(19) United States
(12) Patent Application Publication
(10) Pub. No.: US 2006/0070521 A1
(43) Pub. Date: Apr. 6, 2006

(54) Removable duct liner

(76) Inventors: Stephen K. Stark, Wilmington, DE (US); Robert L. Sassa, Newark, DE (US)

Correspondence Address: W. L. Gore & Associates, Inc., 551 Paper Mill Road, P.O. Box 9206, Newark, DE, 19714-9206, US

(21) Appl. No.: 10/955,315

(22) Filed: Sep. 29, 2004

(51) Int. Cl. B01D 53/22

(52) U.S. Cl. 95/45; 96/4

(57) ABSTRACT

The invention relates to liners for air ducts. Specifically, the invention is an article comprising a porous polymeric membrane layer and, optionally, a support layer, in which the article is a duct liner adapted to be removably positioned within a porous air duct. The liner may also be used in conventional metal and plastic ducts to reduce cleaning frequency. In another aspect, the invention is a porous air duct comprising: a liner comprising a porous polymeric membrane and, optionally, a support layer; and an openwork conduit, said liner disposed within the openwork conduit.

### BACKGROUND OF THE INVENTION

A variety of air handling systems are known in the art for conveying and distributing air from a source of forced air (i.e., a heater, an air-conditioner, a humidifier, a de-humidifier, or any other device which supplies pressurized air) to a room, building, or other enclosure (collectively, a “space”).

One common air handling system utilizes metal or plastic ductwork connected to a forced air source and has spaced registers for discharging air therefrom into the space. Such metal or plastic ductwork air handling systems are problematic, however, because the registers can create drafts, air turbulence, resulting in undesirable temperature variations within the space. Moreover, when the air source delivers air at a lower temperature than the space in which the duct is located, condensation may form on the surface of the duct.

Duct systems using fabric tubes supported by framing systems rather than impermeable metal or plastic structures have been used in certain applications. These systems are inexpensive, lightweight and relatively easy to install. Porous fabric duct systems are particularly advantageous in spaces that are large, or where drafts are to be prevented or condensation is of particular concern.

To minimize drafts, some fabric duct systems distribute air through air permeable fabrics. Pressurized air from the air source inflates the fabric tubing and the tubing slowly disperses air along its entire surface in a uniform manner. These fabric air handling systems are known as “low-throw” devices because the air is delivered through the porous fabric resulting in reduced air velocity at the surface of the fabric. As the air flows through the fabric, some dust will be trapped. Consequently, such systems may offer limited secondary filtration, which may improve air quality in the space. However, this also necessitates frequent cleaning to maintain air permeability.

Other fabric air distribution systems are constructed of less porous or non-porous fabric having openings or vents formed therein. Similar to the spaced registers found in metal and plastic ductwork, the openings allow air to exit the tubing, which permits the air to be directed in specific directions and induces desired circulatory patterns within the space. Such fabric air distribution systems are known as “high-throw” systems because they have a much higher air outlet velocity than low-throw systems. High-throw devices enjoy most of the benefits of fabric air ducts, however because traditional fabrics may require additional processes to reduce permeability, these fabrics may be more expensive. Typically, permeability is reduced by coating, laminating or calandering the materials.

All fabric duct systems benefit from lower capital cost, faster installation and improved air distribution when compared to metal ducts. Moreover, the fabric used in these systems can be washed periodically when it is covered with dust. Air flowing through the fabric of low throw fabric ducts reduces condensation on the duct surface. Unfortunately, fabric ducts require relatively frequent cleaning and the task of removing, washing, and reinstalling the fabric is complicated and expensive. During removal and reinstallation, the duct may be damaged and there is a high probability of error in the reinstallation process.

A conical air filter is disclosed in U.S. Pat. No. 6,626,754 to Gebke. The conical filter described therein is intended to remove particles from a cylindrical air duct of metal or fabric construction. The conical shape is deemed necessary to prevent fluttering of the filter within the duct. However, the because of the small surface area of the conical filter, the air permeability must be very high to permit the high velocity air flow through the filter. Consequently, the filter performance is poor, and the filter will require relatively frequent replacement.

What is needed is an air handling system that has the advantages of fabric duct systems, but which minimizes the need for frequent removal, cleaning and reinstallation of the fabric. It is also desirable to provide a liner to a porous air duct that has good filtration performance to improve air quality. There is also a need for a fabric duct system utilizing lower-cost, high permeability fabrics.

### SUMMARY OF THE INVENTION

In one aspect, the invention is an article comprising a porous polymeric membrane layer and a support layer, in which the article is a duct liner adapted to be removably positioned within a porous air duct.

In another aspect, the invention is a porous air duct comprising: a liner comprising a porous polymeric membrane and a support layer; and an openwork conduit, said liner disposed within the openwork conduit.

In a further aspect, the invention provides a method of installing a tubular duct liner within a porous air duct having a proximate end in communication with an air supply and a distal end within a space, the porous air duct being adapted to direct pressurized air from the air supply to the space, in which the method comprises: providing a tubular duct liner, the liner having an proximate end and a distal end, the proximate end having an inlet for receiving air from the pressurized air supply, rolling up the tubular duct liner from the distal end of the tubular duct liner to the proximate end of the tubular duct liner; placing the tubular duct liner into the porous air duct adjacent to the proximate end of the porous air duct, and inflating the tubular duct liner within the porous air duct by directing pressurized air into the inlet of the tubular duct liner, whereby the tubular duct liner is unrolled within the porous air duct by air pressure within the tubular duct liner.

### DESCRIPTION OF THE DRAWINGS

FIG. 1 shows a cross section through a liner for a porous air duct according to the present invention.

FIGS. 2a and 2b show a liner in accordance with the present invention in the inflated and deflated positions, respectively.

FIG. 3 shows the duct liner of the present invention, as it is folded in preparation for installation in a duct.

FIG. 4 shows a duct liner as it is inflated and installed in a duct.

FIG. 5 shows the inventive liner as it is deployed in an openwork duct.

FIG. 6 shows a duct liner in accordence with one aspect of the invention, wherein the liner is being removed by pulling a cord attached to the distal end of the liner to invert the liner and withdraw it from the duct.

FIG. 7 shows a liner constructed of an array of tubular components.

### DETAILED DESCRIPTION OF THE INVENTION

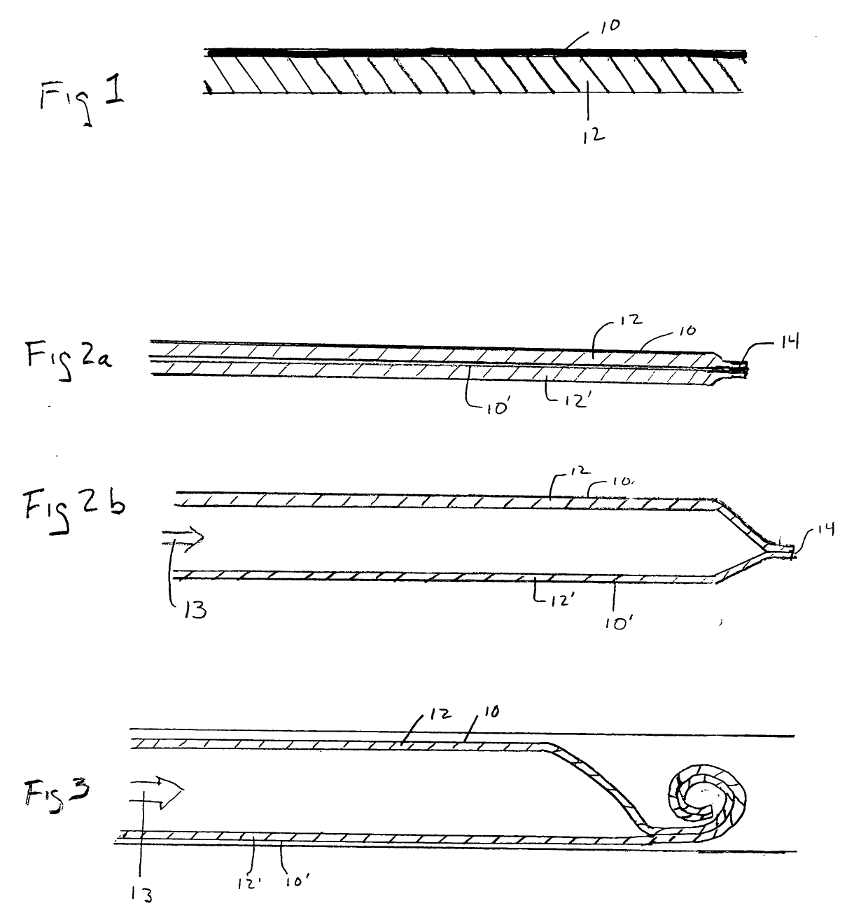

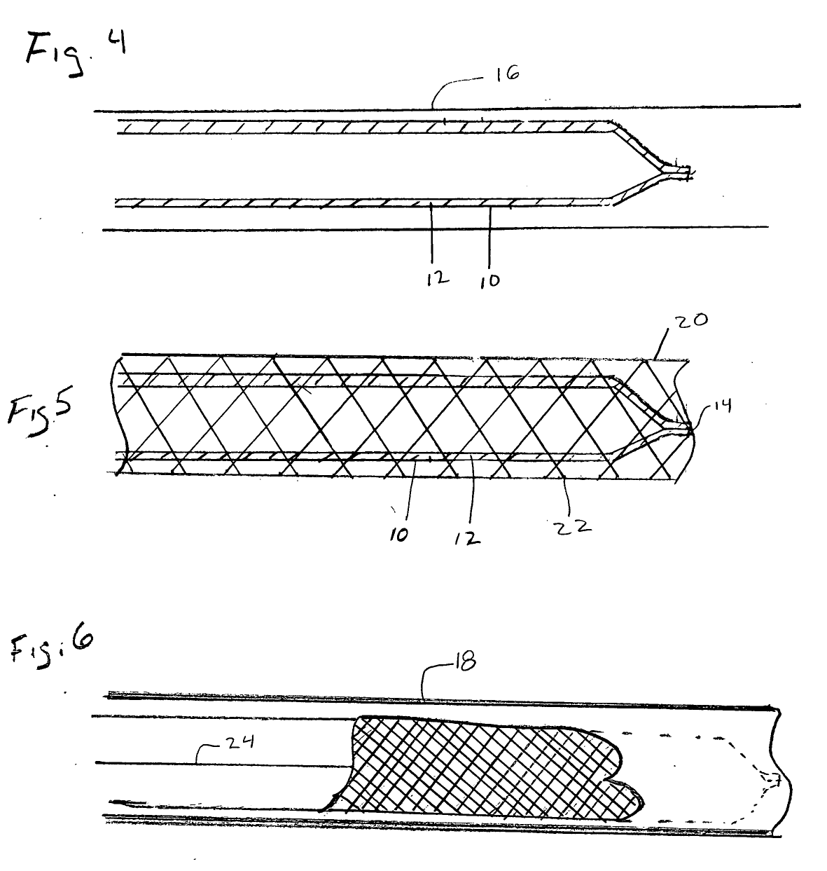

The duct liner is constructed of a porous polymeric membrane and, optionaly, a support layer. With reference to FIGS. 1-2, a polymeric membrane 10 is provided with a support layer 12 to form the liner wall material. A tubular liner may formed by joining or bonding the longitudinal edges of a pair of rectangular pieces of liner wall material. One end 14 of the tubular liner is also closed by joining or bonding the wall materials, the opposite end is left open as an inlet for supply air.

A variety of porous polymeric membranes can be used as the membrane layer depending on the requirements of the application. Porous polymeric membranes for use in the present invention may be characterized by their polymeric composition and air permeability. Porous polymeric membranes are also often characterized by high filtration efficiency. Accordingly, the appropriate membrane may be selected for its filtration capability

The porous polymeric membrane layer may, for example, be constructed from the following materials: nitrocellulose, triacetyl cellulose, polyamide, polycarbonate, polyethylene, polypropylene, polytetrafluoroethylene, polysulfone, polyvinyl chloride, polyvinylidene fluoride, acrylate copolymer, methacrylate copolymer and the like.

Membranes useful the present invention should exhibit high permeability to air. Air permeability can be determined according to a Frazier Number test method, described below. Membrane permeability can vary from less than 1 Frazier (F) to greater than 100 F. The liner permeability chosen will depend upon the design and permeability of the duct and the intended use of the liner. The duct liner permeability can also be controlled through the process conditions in the lamination step. In one aspect, the air permeability of the duct liner is less than the air permeability of the porous air duct into which it is to be installed. Therefore, the liner may serve as an aid to inflation of the duct.

The most preferred porous polymeric membrane layer used in this invention is a porous polytetrafluoroethylene membrane. Porous expanded PTFE, such as that made in accordance with U.S. Pat. No. 3,953,566 comprises a porous network of polymeric nodes and interconnecting fibrils. These kinds of material are commercially available in a variety of forms from W. L. Gore & Associates, Inc., Newark, Del.

Expanded PTFE is formed when PTFE is heated and rapidly expanded by stretching in at least one direction in the manner described in the above listed patents. As the term “expanded PTFE” of ePTFE is used herein, it is intended to include any PTFE material having a node and fibril structure, including in the range from a slightly expanded structure having fibrils extending from relatively large nodes of polymeric material, to an extremely expanded structure having very long fibrils interconnected by small nodes. The node and fibril structure is identified by microscopy. While the nodes may easily be identified for some structures, many extremely expanded structures consist almost exclusively of fibrils with very small nodes.

The duct liner may also include a support layer. The support layer imparts strength and tear resistance to the liner without a significant loss in air permeability. The support layer may comprise a felt or fabric. Preferably, the support layer is a thin, highly porous, strong, polymeric non woven material. The support layer may be made from any number of polymeric materials or bicomponents thereof, including polypropylene, polyethylene or polyester. Most preferably, the support layer is a polyester/polyethylene bicomponent.

The membrane may be laminated or bonded to the support layer, or a tubular support material may be merely positioned within or outside the tubular membrane. In one embodiment shown in FIG. 2, the liner is constructed of elongated sheets of material bonded at their longitudinal edges to form a tubular liner. One end of the material 14 is also bonded to close the liner. The liner may be constructed by placing two layers of support material 12 between two layers of membrane 10 and heat welding the materials at three edges as described above. In this way, the tubular liner is formed with the support layer in fixed relationship to the membrane.

Alternatively, the membrane is laminated to the support layer. Lamination may be done using conventional methods, equipment and materials known in the art. For example, adhesives may be used. Suitable adhesive materials may be found in, but not limited to, the classes consisting of thermoplastics, thermosets, or reaction curing polymers. The adhesives may be applied to the surfaces of the materials to be laminated, for example, by printing, coating, or spraying methods; and the materials joined using standard lamination equipment.

A preferred method of lamination of the layers is to adhere the layers using thermal fusion bonding techniques. Lamination of the layers by thermal fusion bonding is affected by simultaneous application of heat and pressure to the materials to be joined. This can be done using conventional equipment, for example, with heated platen presses, or by nipping the materials between a heated metal-surface roll and a silicone rubber-surface roll, or the like.

In an alternative configuration of the laminate, the membrane may be affixed to a portion of the surface of the support layer by discontinuous fusion bonding the membrane to the support layer. For example, the discontinuous bond may be in the form of vertical or horizontal lines, a gravure printed pattern or any other configuration whereby the membrane is attached discontinuously to the support layer by fusing or adhering the membrane to the support layer.

The removable duct liners of the present invention find application in a variety of air ducts, including both porous fabric air ducts and impermeable metal or plastic ducts. When used in conjunction with either a porous fabric air duct, or an duct made of impermeable materials, the liner significantly reduces the need for cleaning and may also function as a removable, high capacity filter that improves indoor air quality. Moreover, in fabric ducts, the liners of the present invention may enable the use of less expensive high porosity fabrics. Furthermore, the liner may be used in openwork ducts, which as described below have a substantially open structure that supports the liner.

In one embodiment, the duct liner is used within a low throw porous fabric air duct. In low throw systems, substantially all of the air flows through the fabric of the duct and through the liner. The liner prevents a build up of particles on and within the duct fabric and has better filtration properties than the duct fabric alone, resulting in improved air quality. Because the liner is removable and disposable, the fabric may not require frequent cleaning.

Advantageously, the liner's permeability can be varied, either along the length of the duct, or around its circumference. For example, the liner may have a higher permeability along the bottom of the duct in order to direct more air downward. In another example, the liner has longitudinal sections of higher permeability corresponding to areas for which higher air flow is desired.

In another embodiment, the liner is used in a high throw system. Such systems typically are constructed of somewhat lower permeability fabrics than low throw systems. High throw systems incorporate linear or individual openings along the length of the duct, which direct airflow into the space. Accordingly, the liners of the present invention may include vents that correspond to the fabric duct vents. Liner vents may include holes or regions of higher air permeability in the liner. To prevent misalignment of the vents in the liner with the holes in the duct, the liner and duct may be clipped, pinned or otherwise removably connected at the vents.

The liners of the present invention also have applicability to ducts constructed of impermeable materials. In one embodiment, the liner is substantially of the same dimensions as the interior of the duct. Consequently, in this embodiment, permeability of the liner material is quite low except in the regions corresponding to the outlet registers. Particles may be captured by the liner even without significant air flow from the inside to the outside of the liner material. In this case, the majority of particles may be captured by the regions of high air permeability corresponding to the outlet registers.

In another embodiment, the liners may provide pressure side final filtration in an impermeable duct system. In this embodiment, the liners of the present invention are somewhat smaller in cross section than the cross section of the duct. This increases the surface area available for airflow from inside to outside of the liner, thereby reducing the pressure drop.

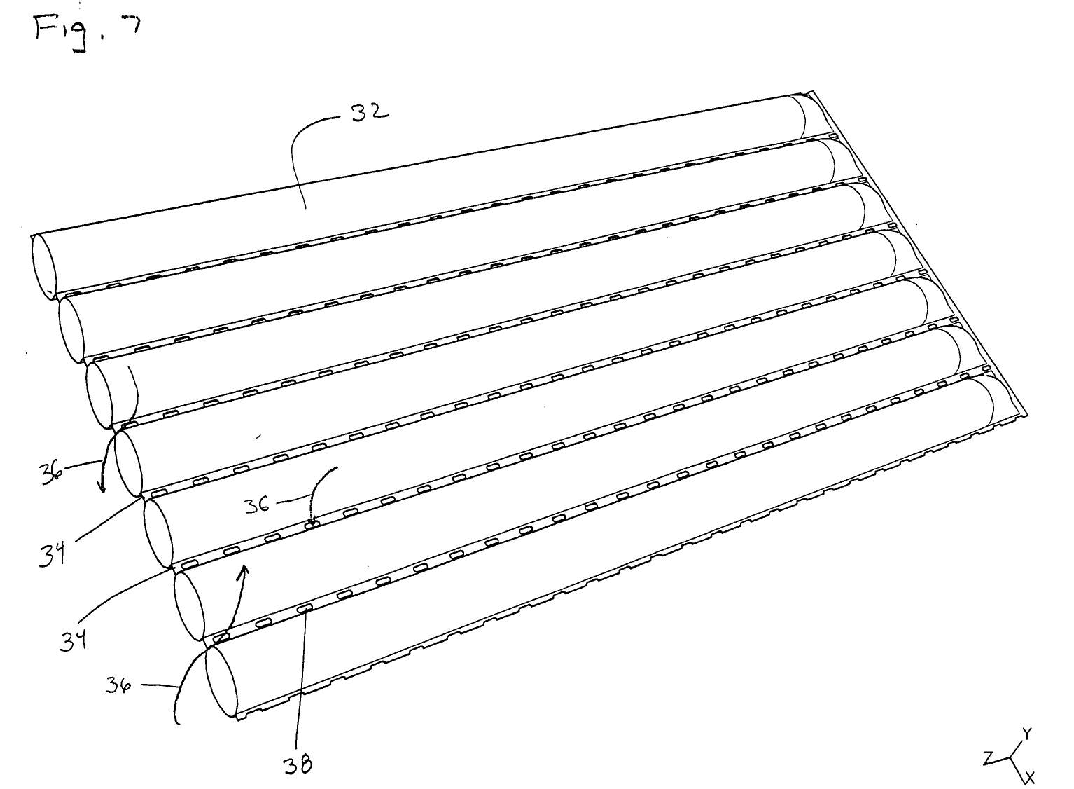

In another aspect, the liner of the present invention is used in an openwork duct. As used herein, an “openwork duct” is an air duct having substantialy open structure therein. An exemplary open work duct is depicted in FIG. 5, showing a conduit 20 constructed of wires 22. Openwork ducts may be constructed of a metal or plastic screen or mesh, or other materials that provide only the structural support for the duct. Because openwork ducts have substantial open area, they will not function to carry airflow without a liner. For example, the openwork duct may comprise a conduit constructed of a stainless steel screen and a porous liner.

The fine pore structure of, for example ePTFE membranes, along with the relatively low velocity of air passing through the inventive liners, enables the liner to provide very high filtration efficiency including HEPA or even ULPA. Such high filtration efficiency may eliminate the need for pre-filters for air handling equipment such as fans and heat exchangers. Significantly, the liners acheive this filtration performance without significantly increasing the pressure drop accross the porous duct.

Many duct configurations include long lengths and or sharp corners that can make installing or removing a single duct liner difficult. In such cases, the duct liner may comprise multiple sections. Access may be provided at appropriate points near bends or at regularly spaced intervals. Where two or more liners are used in series in a single duct, only the down stream-most duct, with reference to the direction of air flow, will have the discharge end closed off. The upstream liner sections will have open ends. In this way, the pressure drop between consecutive liner sections minimized.

Regardless of the application, the duct liners of the present invention may incorporate anti-microbial and flame retandant treatments. Microbes such as bacteria and mold can multiply on a filter surface clogging the filter. Anti-microbial treatment inhibits the growth of microbes that foul the filter surface, which helps to extend filter life.

The duct liners of the present invention advantageously permit the use of relatively lower cost, higher permeability fabrics in porous air ducts. To maintain internal pressures that are sufficient keep a porous air duct inflated, the duct fabric cannot be overly permeable. Many economical fabrics are too permeable to remain inflated. Lowering the permeability of these fabrics often requires secondary processing, such as calandering or coatings be applied to the duct fabric, as disclosed in U.S. Pat. No. 6,565,430 to Gebke. Alternatively, duct liners of the present invention can be selected to have an air permeability that is less than the air permeability of the porous fabric duct. Provided that the liner is substantially of the same dimension as the duct, the liner will help to support the porous duct and keep it inflated.

Regardless of the type of duct they are installed within, the liners of the present invention may incorporate a novel deployment and removal means. The duct can be easily installed from an access on the supply end of the duct without disassembly or removal of the remaining ductwork.

To prepare it for installation, the liner is folded to a width somewhat less than that of the diameter or minimum duct cross section. The duct is then rolled from the closed or distal end towards the supply, or proximate end. By using thin materials, the roll diameter is minimized. However, those of skill in the art will appreciate that the diameter of the roll limits the total length of the liner that can be installed in one piece. In some applications, additional access points must be provided, and may be conveniently placed at junctions or bends in the ductwork.

To install the liner, it is inflated with air pressure. Pressure within the liner unrolls the liner and inflates it. Air pressure may be supplied from an external source, such as a fan or blower, or may be provided by the supply air from the air handling system.

FIG. 6 shows another aspect of the invention in partial cut away. As seen in the Figure, the liner may further incorporate a line or cord 24 attached to the remote or distal end of the filter and leading to the proximate end nearest the air supply. To remove the liner, the cord is pulled from the proximate end of the duct or access point. Advantageously, the cord may be disposed within the interior of the liner, so that the liner inverts as it the cord is pulled. Once the distal end reaches the access or proximate end of the ductwork, the entire liner can be pulled out for disposal.

In another application of the claimed invention, a tubular array filter is constructed. As shown in FIG. 7, the array may include several longitudinal elements separated by bonding strips 34. The tubular array may be constructed by positioning two rectangular sheets of support material between two similarly shaped porous polymeric membranes. As described above, the longitudinal edges of the materials are bonded or adhered to create a tubular filter. To construct the tubular array, additional bonding strips are created that are parallel to the longitudinal edges and subdivide the tube into an array of smaller tubes. One end of the tubular array is also closed by bonding a strip across the tubes. The bonding strips may incorporate openings 38 that allow ambient airflow 36 to pass from one side of the tubular array filter to the other. The tubular array may also be pleated to increase filter surface area by folding the array along lines perpendicular to the bonding strips.

The tubular array may be supported and deployed within a rectangular openwork duct, or may be supported only at the bottom by an openwork structure. In the latter embodiment, the tubular array filter may be suspended above a space by simple openwork support.

The open end of the array may be attached to a manifold that distributes supply air to each tubular element. As detailed above, the tubular array may be rolled from the bonded end to the open end to facilitate deployment by inflating the roll within or above the openwork structure.

### TEST METHOD

Frazier Number

In this method, air permeability is measured by clamping a test sample in a gasketed-flanged fixture, which provides a circular test area of approximately 6 square inches (2.75 inches diameter) for air flow measurement. The upstream side of the sample fixture is connected to a flow meter in line with a source of dry compressed air. The downstream side of the sample fixture is open to the atmosphere. Testing is accomplished by applying an air pressure of 0.5 inches of water to the upstream side of the sample and recording the flow rate of the air passing through the in-line flowmeter (a ball-float rotameter). The sample is conditioned at 70° F. and 65% relative humidity for at least 4 hours prior to testing. Results are reported in terms of Frazier Number, which has units of cubic feet/minute/square foot of sample at 0.5 inches of water pressure.

Particle Filtration Efficiency

Particle collection efficiency was measured by an automated tester (Model 8160 from TSI, Inc., St. Paul, Minn.). A rectangular, flat sheet sample of the filter media (68 mm×95 mm; 2.675″×3.75″) was enclosed in the filter holder with gasket seals mounted horizontally. The circular filter holder had two zones, a center test zone which allows air flow and test particles to pass through and an outer guard zone to prevent leakage of air flow between the test zone and the atmosphere. The differential pressure between the two zones was adjusted to near zero so that no outside air leaks into the test zone. The test zone had an area of approximately 65 cm².

A dioctyl pthalate (DOP) solution was atomized to generate a polydisperse aerosol. The aerosol particles were then classified according to their electrical mobilities to generate monodisperse particles from 0.03 to 0.4 micrometer in diameter. The particles were then passed to the test filter. Two condensation nucleus particle counters simultaneously measured the particle concentrations upstream and downstream of the filter to determine the particle collection efficiency.

The efficiency was reported as the percentage of particles collected by the filter relative to the upstream challenge particles. The pressure drop was recorded in mm of water gauge. The test was performed at a media face velocity of 5.3 cm/s.

The test was performed at ambient room temperature (70 degrees F.) and humidity conditions (40% R.H.).

### EXAMPLES

### Example 1

A removable liner for a fabric duct was constructed as follows:

A porous expanded polytetrafluoroethylene film having an air permeability of about 40 F was used as the membrane layer. The membrane is available from W.L. Gore and Associates, Inc., Newark, Del. For support, a polyethylene/polyester spun bond bicomponent nonwoven having a basis weight of 0.45 oz/yd² (15 g/m²) was used. The material is available from Marubeni America Corp. under the trade name MARIX®.

A sample of material was tested to determine its filtration efficiency and air permeability. The liner performance is contrasted with the performance of known commercially available porous duct materials availble from Ductsox® Fabric Air Dispersion Products, Dubuque, Iowa. The results are reported in Table 1. It is clear from the data that the duct liners of the present invention show improved filtration performance without sacrificing air permeability. Thus the liner will not signifcantly alter the pressure drop accross a porous fabric air duct, but may markedly improve air quality and reduce fabric cleaning.

TABLE 1

| Particle Size | Example 1 | Example 2 | | | |
|---|---|---|---|---|---|
| (0.3 micron) | 40F | 18F | Stat-X ^{Tm} | Microbe-X ^{R} | Sedona ^{Tm} |
| Collection Efficiency (%) | 98.3 | 99.5 | 14.0 | 3.9 | 19.5 |
| Air Permeability (F.) | 18.0 | 6.0 | 2.5 | 29.0 | 2.0 |

### Example 2

An 18 F polytetrafluoroethylene filter membrane was laminated to a 15 g/m² polyetheylene/polyester bicomponent spun bond.

Two sheets measuring 414″ (10,515 mm) long and 18″ wide were cut from each of the membrane and the support materials. The sheets were superimposed upon each other such the two sheets of support material were positioned between two sheets of membrane material. Both longitudinal edges were heat welded using a hand iron such that all the sheets were joined at the edges. The edges were welded with a 1⅝″ (41 mm) wide weld using a hand iron manufactured by Heat Seal, Inc., Cleveland Ohio. The sealing was performed with the iron adjusted to the high temperature setting. The welder was run along the inside of two reference lines that were spaced 18″ apart. The welding formed a flattened tube approximately 18″ wide. One end of the tube was also heat welded to form the porous duct liner.

The porous duct liner was folded and rolled up to prepare it for installation in a porous fabric air duct. Both longitudinal edges were folded toward the center such that the width of the folded liner was about ⅓ that of the unfolded liner. The liner was then tightly rolled from the closed end of the tube towards the open end.

To deploy the liner, it was placed at the upstream end of the porous air duct (hereinafter the “proximate end”). Pressurized air from an air source was supplied to the inside of the liner through the open end of the tubular liner. As pressure built within the liner, the liner inflated and unrolled down the length of the duct.

While particular embodiments of the present invention have been illustrated and described herein, the present invention should not be limited to such illustrations and descriptions. It should be apparent that changes and modifications may be incorporated and embodied as part of the present invention within the scope of the following claims.

The invention claimed is:

1. An article for lining a porous air duct, said article comprising a tubular porous polymeric membrane, wherein said article is adapted to be removably positioned within said porous air duct.

2. An article comprising a porous polymeric membrane layer and a support layer, in which said article is a duct liner adapted to be removably positioned within a porous air duct.

3. A liner for a porous air duct comprising at least one tubular element, said tubular element comprising a porous polymeric membrane, said tubular element having a first open end and second closed end opposite said first open end.

4. The liner of claim 3, wherein said at least one tubular element comprises multiple tubular sections.

5. The article of claim 1 or claim 2, in which the polymeric membrane layer comprises porous ePTFE.

6. The article of claim 1 or claim 2, in which the polymeric membrane layer comprises porous polyolefin.

7. The article of claim 2, in which the membrane is laminated to the support layer.

8. The article of claim 2, in which the support layer comprises a material selected from the group consisting of polyethylenes, polypropylenes, polyesters and polyamides and bi-components thereof.

9. The article of claim 2, in which said support layer comprises bi-component polyethylene and polyester spunbond.

10. The article of claim 2, in which the support layer comprises a melt blown fibrous web.

11. The article of claim 2, in which the article is tubular.

12. The article of claim 1 or claim 11, in which said article is substantially the same length as said porous air duct.

13. The article of claim 11, in which the air permeability of the article varies along its length.

14. The article of claim 1 or claim 11, in which the air permeability of the article varies along its circumference.

15. The article of claim 1 or claim 11, in which the porous air duct comprises at least one hole, and the article further comprises at least one liner vent corresponding to the at least one hole.

16. The article of claim 1 or claim 2, in which the article further comprises anti-microbial treatment.

17. The article of claim 1 or claim 2, in which the article further comprises flame-retardant treatment.

18. The article of claim 1 or claim 11, in which said article further comprises a means for removing said article from said porous air duct.

19. The article of claim 18, in which the article has a proximate end and a distal end, said article further comprising a cord attached to the distal end of said article and extending substantially to the proximate end of said article, whereby the article is removable from said porous air duct by pulling said cord from said porous air duct.

20. The article of claim 19, in which the cord is disposed within the article, such that the article is inverted by pulling the cord toward the proximate end of the article.

21. The article of claim 19, in which the porous air duct comprises an access adjacent to the distal end of said porous air duct, said access adapted to permit installation and removal of said article from said porous air duct.

22. A tubular liner for a porous air duct, said tubular liner comprising a porous polymeric membrane and a support layer, said tubular liner further comprising an upper portion having a first air permeability and a lower portion having a second air permeability, wherein the first air permeability is different from the second air permeability.

23. The tubular liner of claim 22, in which the second air permeability is greater than the first air permeability.

24. The method of distributing air from an air source to a space, the method comprising:
a) providing a porous air duct, said porous air duct having a proximate end in fluid communication with said air source and a distal end within said space,
b) providing a removable liner within said porous air duct, said removable liner comprising a porous polymeric membrane and a support layer, and
c) providing air from said air source to said space through said removable liner and said porous air duct.

25. The method of distributing air to a space of claim 24, in which the porous polymeric membrane comprises ePTFE.

26. The method of distributing air to a space of claim 24, in which the removable liner further comprises a cord attached to the distal end of said removable liner and extending substantially to the proximate end of said removable liner, wherein the removable liner is removable from the porous air duct by pulling said cord toward the proximate end of said removable liner.

27. The method of claim 26, in which the cord is disposed within the article, such that the article is inverted by pulling the cord toward the proximate end of the article.

28. The method of installing a tubular duct liner within a porous air duct, said porous air duct having a proximate end in communication with an air supply and a distal end within a space, the porous air duct adapted to direct pressurized air from said air supply to said space, the method comprising:
a) providing a tubular duct liner, said liner having an proximate end and a distal end, said proximate end having an inlet for receiving air from said pressurized air supply,
b) rolling up the tubular duct liner from the distal end of the tubular duct liner to the proximate end of the tubular duct liner;
c) placing the tubular duct liner into said porous air duct adjacent to the proximate end of said porous air duct, and
d) inflating the tubular duct liner within said porous air duct by directing pressurized air into said inlet of said tubular duct liner, whereby the tubular duct liner is unrolled within the porous air duct by air pressure within the tubular duct liner.

29. The method of claim 28, in which the tubular duct liner is inflated by pressurized air from said air supply.

30. A liner for a porous air duct, said porous air duct having a first air permeability, said liner having a second air permeability, in which the first permeability is greater than the second permeability.

31. A porous air duct comprising:
a) a tubular air duct comprising porous fabric; and
b) a tubular liner removably positioned within said porous fabric air duct, said tubular liner comprising a porous polymeric membrane.

32. A porous air duct comprising:
a) an openwork conduit, and
b) a tubular liner disposed within said openwork conduit, said tubular liner comprising a porous polymeric membrane.

33. The porous air duct of claim 31 or claim 32 in which said tubular liner further comprises a polymeric support layer.

34. An article for lining an air duct, said article comprising a tubular porous polymeric membrane adapted to be removeably installed and inflated within said air duct.

33. A porous air duct comprising:
a) a first tubular element comprising a porous polymeric membrane, said first element having a first open end and second closed end opposite said first open end,
b) a second tubular element comprising a porous polymeric membrane, said second tubular element having a first open end and second closed end opposite said first end, wherein said first tubular element and said second tubular element are attached such that said first and second tubular elements are substantially parallel and said open end of said first tubular element is adjacent to said open end of said second tubular element, and
c) an openwork support adjacent to at least one surface of the tubular elements.

34. The porous air duct of claim 33 in which the openwork support comprises a rectangular openwork duct.

35. The porous air duct of claim 33 in which the openwork support is planar.

36. The porous air duct of claim 33 further comprising plurality of tubular elements having a first open end and second closed end opposite said first end, said tubular elements positioned substantially parallel to the first tubular element.

37. The porous air duct of claim 33 in which the tubular elements are connected by strips having openings therein.
